(19) United States
(12) Patent Application Publication
(10) Pub. No.: US 2008/0282547 A1
(43) Pub. Date: Nov. 20, 2008

(54) Knife with a Retracting Blade, Usable in Particular in a Hostile Environment

(75) Inventors: Vincent Leger, Aix en Provence (FR); Jean-Marc Wadoux, Pertuis (FR)

Correspondence Address: THELEN LLP, P. O. BOX 640640, SAN JOSE, CA, 95164-0640, US

(73) Assignee: AREVA NC, PARIS (FR)

(21) Appl. No.: 12/094,128

(22) PCT Filed: Nov. 17, 2006
(86) PCT No.: PCT/EP2006/068599

§ 371 Date: May 16, 2008

(30) Foreign Application Priority Data
Nov. 23, 2005 (FR) 05 53571

(51) Int. Cl. B26B 1/08

(52) U.S. Cl. 30/162

(57) ABSTRACT

A knife includes a sheath (1), a handle (2) at the rear, a sliding blade, an operating system that includes a trigger (11) below the handle and a transmission connecting rod, in addition to a gripping bar (9). The tool is grasped with both hands, providing sufficient dexterity even in difficult in conditions. Designed for working in a hostile environment.

### CROSS REFERENCE TO RELATED APPLICATIONS OR PRIORITY CLAIM

This application is a national phase of International Application No. PCT/EP2006/068599, entitled “KNIFE WITH RETRACTABLE BLADE, USABLE PARTICULARLY IN A HOSTILE ENVIRONMENT”, which was filed on Nov. 17, 2006, and which claims priority of French Patent Application No. 05 53571, filed Nov. 23, 2005.

The subject of this invention is a knife with a retracting blade (a “cutter”) adapted to work in particular conditions, such as in hostile environments in which direct grasping of the tool is impossible.

Working in a hostile environment is accomplished by means either of glove boxes in which the operator inserts his (or her) arm or into remote-manipulation arrangements with a master arm and slave arm that copy the movements of the operator on the other side of a protective wall. The operator is unable to achieve complete freedom of movement and does not feel the same sensations as would be felt working normally, thus reducing dexterity. Many tasks therefore become difficult to execute, among which, in the application considered here with retracting knives, the movements to open and retract the blade, and locking of the blade at the chosen position, which are usually achieved by manipulating small mechanisms on the knives. The knives must also be grasped in different ways according to whether one is moving or adjusting the blade, resulting in fastidious procedures. Finally, the clumsy movements most likely to occur increase the risk of accidents when the blade is open.

The invention was designed in order to eliminate these various drawbacks. It relates an advanced knife of the type indicated, which allows fairly easy manipulation even in difficult conditions, and in good conditions of safety.

In its most general form, it relates a knife that includes a sheath, a handle attached behind the sheath, and a blade sliding in the sheath so as to retract completely into the sheath or to be extended out of the front of the sheath, characterised in that it includes an operating system of the blade, composed of a movable trigger under the handle with a connecting rod connecting the trigger to the blade, and a gripping bar hinged onto the sheath.

The operator grasps the knife by the handle with one hand and by the gripping bar with the other hand. He therefore has the use of both hands to move the knife and to press onto it during use, providing sufficient dexterity even when required to work with arms extended through a glove box or to manipulate a remote-control arm. Control of the blade is exerted by a tightening motion of the hand holding the handle, without the danger of moving the hand in relation to the knife with the risk of also moving the knife away from the position attained. Stable grasping of the knife is therefore achieved with no interruption while the work is being executed.

It is advantageous that the trigger also includes a return spring to retract the blade automatically as soon as the trigger is released, with the operator required only to open his hand. The operating system also advantageously includes a safety hasp that holds the blade retracted except when the hasp is moved. A stop device placed on the operating system can limit the travel distance of the blade. Finally, an additional protection device can be added. This amounts to a beak-like cap connected to the sheath by a hinged joint located above the blade, and that includes a cover located in front of the blade and two cheek pieces extending along the opposite sides of the blade, the cover and the cheek pieces lying above the blade. In this particular embodiment, the beak-like cap covers the blade at the front but is raised by the amount necessary when the knife is lowered onto an object to be cut, so that the beak-like cap does not impede the work of the blade under the knife.

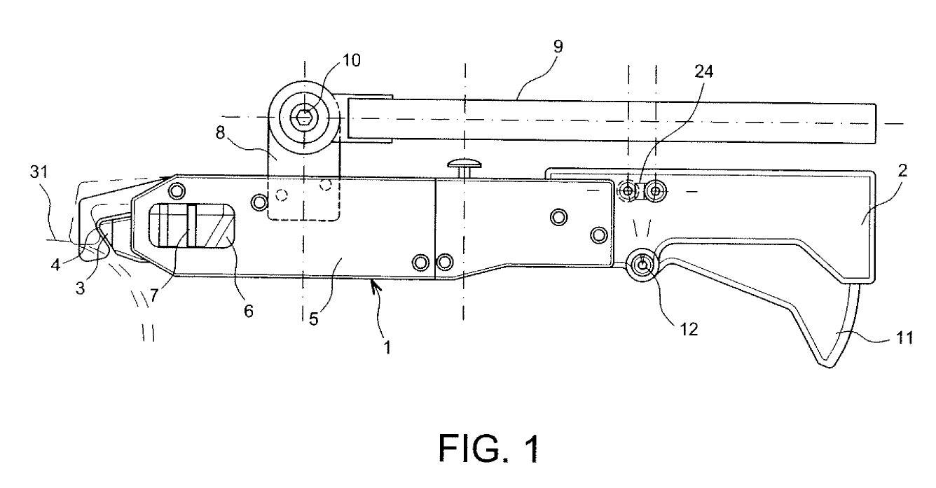

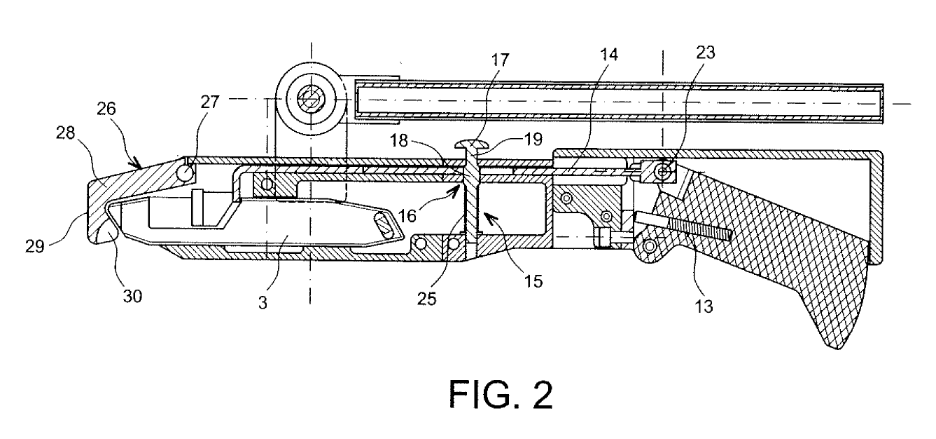

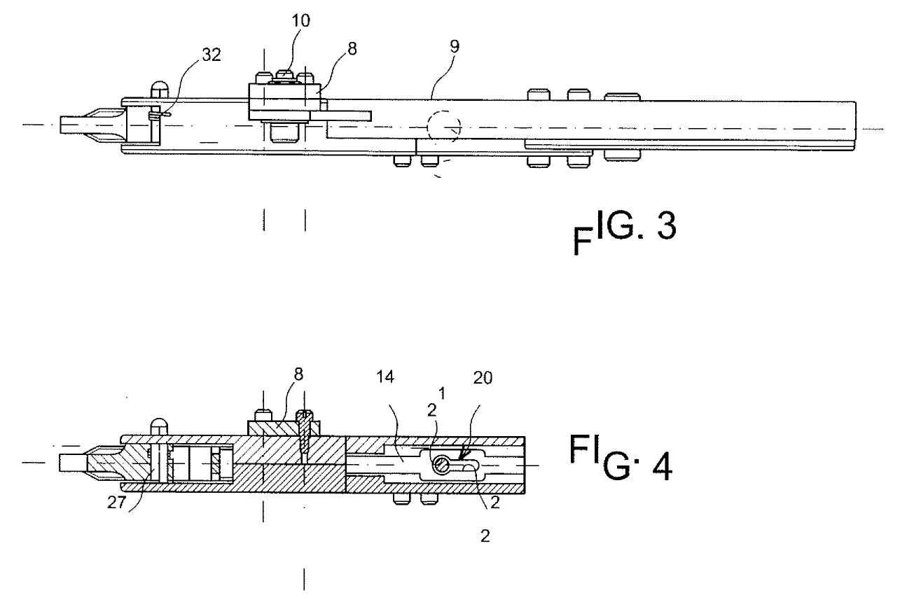

The invention will now be described with reference to the figures, where FIGS. 1 and 2 are side views of the tool from the outside and in section, and FIGS. 3 and 4 are plan views of the tool from the outside and in section.

The description provided above mainly relates FIGS. 1 and 2. The body of the knife includes a sheath 1 at the front and a handle 2 at the rear, which are joined by screws. A blade 3 of an ordinary type, with an oblique front edge that includes a point 4, is housed in the sheath 1 and slides in the latter. The sheath 1 includes a removable cover 5 that is used to create an opening in the latter to provide access to the blade 3 and to replace it. A window 6 is created through the cover 5 in order to render a portion of the blade 3 visible in all circumstances, in order to check its position in relation to a guide mark 7 or other reference mark.

To the sheath 1 is fixed a bracket 8 to which is hinged to a grasping bar 9 on an axle 10 whose direction is crosswise to the knife. The bracket 8 and the bar 9 are located above the sheath 1 and the handle 2. The bar 9 is hinged to the axle 10 so that it makes angle of 0° to 180° in relation to the sheath 1 and to the handle 2.

The knife also includes a trigger 11 extending below the handle 2, through an opening in the latter, and hinged to it by a transverse axle 12 at the front. When grasping the handle 2, the operator can operate the trigger 11 simply by closing the hand. A return spring 13 returns the trigger 11 to its released position.

A connecting rod 14 is hinged to the trigger 11 by its rear end and to the blade 3 by its front end. When the trigger 11 is operated, the connecting rod 14 slides forward and drives the blade 3 so as to push the end of the latter out of the sheath 1. When the trigger 11 returns to its released position, the blade 3 is retracted. However a hasp prevents these movements, unless it has first been moved. This consists of a rod 16 traversing the sheath 1 and ending on a push-button 17 at its upper end, above the sheath 1. The rod 16 includes a thick part 18 and a thin part 19 above the first. In addition (see FIG. 4), it passes through a groove 20 in the connecting rod 14 that includes a wide part 21 at the front and a narrow part 22 at the rear. When the button 17 is released, the rod 16 moves along the groove 20 to the thick part 18, which is adjusted to the wide part 21 of the groove 20 and blocks the connecting rod 14, but when the button 17 is pressed, the rod 16 passes through the connecting rod 14 to the thin part 19, which is adjusted to the narrow part 22 of the groove 20, whose length is much greater than that of the wide part 21, thus allowing the connecting rod 14 to slide.

A return spring 25 compressed between the thick part 18 and the sheath 1 pushes the hasp 15 upwards and maintains the locked position.

The axle of the hinged joint 23 at the rear of the connecting rod 14 is able to act as a stop device, by moving from one end to the other of a cutout 24 created in the handle 2.

A beak-like cap 26 is located at the front of the sheath 1, to which it is hinged by an axle making a hinged joint 27 crosswise to the upper part of the sheath 1. After a lever 28, the beak-like cap 26 includes a protective part that includes a front cover 29 and two side cheek pieces 30. When the blade 3 is opened, the point 4 extends between the cheek pieces 30 that are covering it and that lie above it, as does the cover 29. When the knife is lowered onto an object to be cut 31, the beak-like cap 26, pushed upwards by the said object 31, pivots upwards so that it uncovers the blade 3 slightly, and allows the point 4 to make contact with the object 31 to as to execute the work. When the knife is lifted, a torsion sprint 32 placed around the axle 27 returns the beak-like cap 26 to the closed position, as shown in FIG. 3.

1. A knife that includes a sheath (1), a handle (2) attached behind the sheath, and a blade (3) sliding in the sheath so as to retract completely into the sheath or to extend out of the front of the sheath, characterised in that it includes an operating system of the blade composed of a mobile trigger (11) under the handle, a connecting rod (14) connecting the trigger to the blade, and a gripping bar (9) hinged to the sheath.

2. The knife according to claim 1, characterised in that the trigger includes a return spring (13).

3. The knife according to claim 1, characterised in that the operating system includes a hasp.

4. The knife according to claim 3, characterised in that the hasp includes a button (17) extending out of the sheath, returned by a spring (29), and includes a rod (16) with a thick part (18) and a thin part (19), and in that the connecting rod (14) includes a groove (20) traversed by the rod, the groove including a wide part (21) in which the thick part is adjusted and a narrow part (22) in which the thin part slides.

5. The knife according to claim 1, characterised in that the operating system includes end stops (23).

6. The knife according to claim 1, characterised in that it includes a beak-like mobile protective cap (26) covering the blade (3) at the front of the sheath (1).

7. The knife according to claim 6, characterised in that the beak-like cap is connected to the sheath by an axle with a hinged joint (27) located above the blade, and includes a cover (29) located in front of the blade and two cheek pieces (30) extending along the opposite sides of the blade, the cover and the cheek pieces extending below the blade.
